(19) United States
(12) Patent Application Publication
(10) Pub. No.: US 2003/0206346 A1
(43) Pub. Date: Nov. 6, 2003

(54) Low loss optical cascade devices

(76) Inventors: Jianying Cao, San Jose, CA (US); Yifan Li, North York (CA); Charles X.W. Qian, Cupertino, CA (US); Yi Qin, Pleasanton, CA (US)

Correspondence Address: LEONARD TACHNER, A PROFESSIONAL, LAW CORPORATION, SUITE 38-E, 17961 SKY PARK CIRCLE, IRVINE, CA, 92614-6364, US

(21) Appl. No.: 10/140,278

(22) Filed: May 6, 2002

(51) Int. Cl. G02B 5/30; G02B 27/28; G02B 27/00; G02B 5/28

(52) U.S. Cl. 359/484; 359/485; 359/502; 359/577; 359/589

(57) ABSTRACT

A combination comprising a cascade of several optical devices with a low overall insertion loss, is disclosed. This arrangement can be used in many applications in the new technology area of dense wavelength division multiplexing. Specifically, this cascade arrangement can be used to fabricate compact, multichannel filter devices, dispersion compensators and other useful devices. Various embodiments are disclosed. In one embodiment, a 45-degree Faraday rotator is combined with another optical element. In another embodiment, a cascade of three optical devices is employed. Central to this is cascade is a cubic polarizing beam splitter (PBS) with four optical surfaces. In yet another embodiment, a cascade of five optical devices is described. Central to this cascade is an elongated polarizing beam splitter with six areas for optical coupling. This elongated PBS functions as a superposition of two cubic PBS. Various embodiments of the elongated PBS are also described. Another embodiment comprises a combination of a 45-degree Faraday rotator and a Gires-Tournois (GT) mirror.

### BACKGROUND OF THE INVENTION

1. Field of the Invention

The present invention relates generally to the field of optical communications and more particularly to devices for use in dense wavelength division multiplexing (DWDM) applications.

2. Background Art

Optical communication has been an active area of development and is crucial to the enhancement of several key technological advancements, e.g., Internet and related new technologies. An important aspect of optical communications that enabled a higher data transmission rate is dense wavelength division multiplexing (DWDM) technology. In many DWDM applications, there is a need to have a cascade of optical devices, each performing a desired task. There are two commonly used prior art technologies to make such cascade devices. The first is to make individual devices with input and output fiber collimators. The cascade is then realized by fusing the optical fibers of several individual devices together. In fact, a majority of DWDM filtering modules and add/drop modules are made in this way. The main disadvantage of this prior art is that the overall insertion loss is quite large. The dominating contributors to the net insertion loss are the optical fiber collimators. A second and less commonly used prior art approach is to use free space cascades and to couple light at the entrances and exits of the device. The major disadvantage of this approach is that it is difficult to achieve highly reliable performance due to the long path lengths associated with these devices. There is a need therefore to provide a technique for achieving a reliable low loss cascade.

### SUMMARY OF THE INVENTION

The present invention comprises a new combination or cascade of several optical devices with a low overall insertion loss. This arrangement can be used in many applications in the new technology area of dense wavelength division multiplexing. Specifically, this cascade arrangement can be used to fabricate compact, multichannel filtering devices, dispersion compensators and other optical devices. Various embodiments are disclosed. In one embodiment, a 45-degree Faraday rotator is combined with another optical filtering element. This combination ensures that for a linearly polarized incoming light; the reflected beam has a polarization perpendicular to that of the incoming light. In another embodiment, a cascade of three optical devices is employed. Central to this cascade is a cubic polarizing beam splitter (PBS) with four optical surfaces. In yet another embodiment, a cascade of five optical devices is described. Central to this cascade is an elongated polarization beam splitter with six areas for optical coupling. This elongated PBS function is a superposition of two cubic PBS. Various embodiments of the elongated PBS are also described. Another embodiment comprises a combination of a 45-degree Faraday rotator and a Gires-Tournois (GT) mirror. This combination rotates the polarization of the incoming light by 90 degrees, reflecting it and producing a periodic phase modification. In yet another embodiment, a cascade with four GT mirrors is described. Such a cascade provides periodic dispersion compensation and can be used to correct chromatic dispersion caused by optical fiber.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 depicts an inline combination of a 45-degree Faraday rotator and another filtering and/or reflecting optics;

FIG. 2 illustrates an optical cascade of three optical filtering elements with a coupling PBS and a dual fiber collimator;

FIG. 3 displays an optical cascade of five optical filtering elements with a coupling PBS and a dual fiber collimator;

FIG. 4, comprising FIGS. 4A through 4C, displays three possible PBS used for five element cascades;

FIG. 5 illustrates an FSR adjustable reflecting device in accordance with an embodiment of the present invention;

FIG. 6 illustrates examples of a multichannel chromatic dispersion compensator using four GT mirrors; and

FIG. 7 is a graphic display of the dispersion curve of a cascade device (chromatic dispersion compensator) comprising three GT mirrors.

### DETAILED DESCRIPTION OF THE INVENTION

The present invention comprises a new method and arrangement to achieve a cascade device of multiple optical elements. The basic concept is closely related to a class of optical devices known as polarization insensitive circulators. Basically, the incoming light is branched into two distinct polarization components. Through the use of a PBS, Faraday rotators and optical filtering elements, the two polarization components are recombined as outputs.

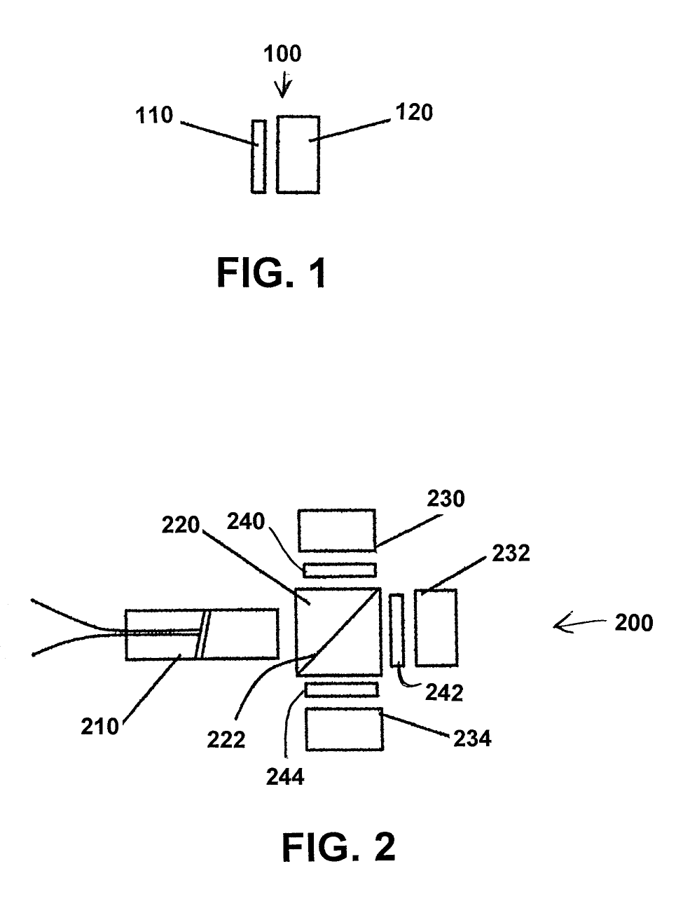

One preferred embodiment 100 of the present invention is illustrated in FIG. 1. A 45-degree Faraday rotator (110) is placed inline with an optical filtering element (120). In this combination the polarization of the reflected beam is rotated by 90 degrees from that of the incoming light. Element 120 can be a DWDM filter, in which case a selection of optical channels are transmitted through the filter while remaining channels are reflected back. In order to reduce the insertion loss of the unit, both surfaces of the Faraday rotator and one of the surfaces of the filtering element are normally coated with anti-reflective coatings. The Faraday rotator and the filtering element may be glued or optically contacted to one another to form a single unit. In certain applications the optical filtering element may be replaced with a group of elements to modify the intensity, phase and polarization states of the incoming light and to reflect the modified beam.

A functional cascade device is illustrated in FIG. 2. This device (200) is a cascade of three optical filtering elements (230, 232, and 234). The cascade is utilized through a cubic PBS (220) and three 45-degree Faraday rotators. The (240, 242, 244) PBS is typically formed with two right angle prisms combined with their interface 222 coated to deflect the s-polarization component of the incident beam. In order to reduce the overall insertion loss of the device, the four optical surfaces of the PBS, one of the surfaces of the filtering elements, as well as both surfaces of the Faraday rotators have anti-reflective coatings. The s-polarization component of the incoming light is first deflected towards filtering element 230, through a 45-degree Faraday rotator 240. A selection of optical channels pass through the optical filter and are collected through an output collimator (not shown in the figure). The reflected beam that contains the remaining channels, has its polarization rotated by 90 degree as it passed through the Faraday rotator 240 twice. The beam then passes through the PBS 220 and the second Faraday rotator 244 and reaches filtering element 234. Again, a selection of optical channels pass through the optical filter 234 and are collected through another output collimator (not shown). The reflected beam that contains the remaining channels, has its polarization rotated by another 90 degree as it passed through the second Faraday rotator 244 twice. The beam is then deflected by the PBS and reaches the third filtering element 232 through the third Faraday rotator 242. Again, a selection of optical channels pass through the optical filter 232 and are collected through yet another output collimator (not shown). The reflected beam that contains the remaining channels, has its polarization rotated by yet another 90 degree as it passed through the third Faraday rotator 242 twice. The beam then passes through PBS 220 and is collected in the output fiber through the input/output collimator (210). The p-polarization component also reaches all three filtering elements in a similar fashion. It reaches 232 first, followed by 234 and 230. It also returns to the output fiber through the input/output collimator. The corresponding selected channels associated with the s-polarization also pass through the three filters and are collected through three output collimators (not shown).

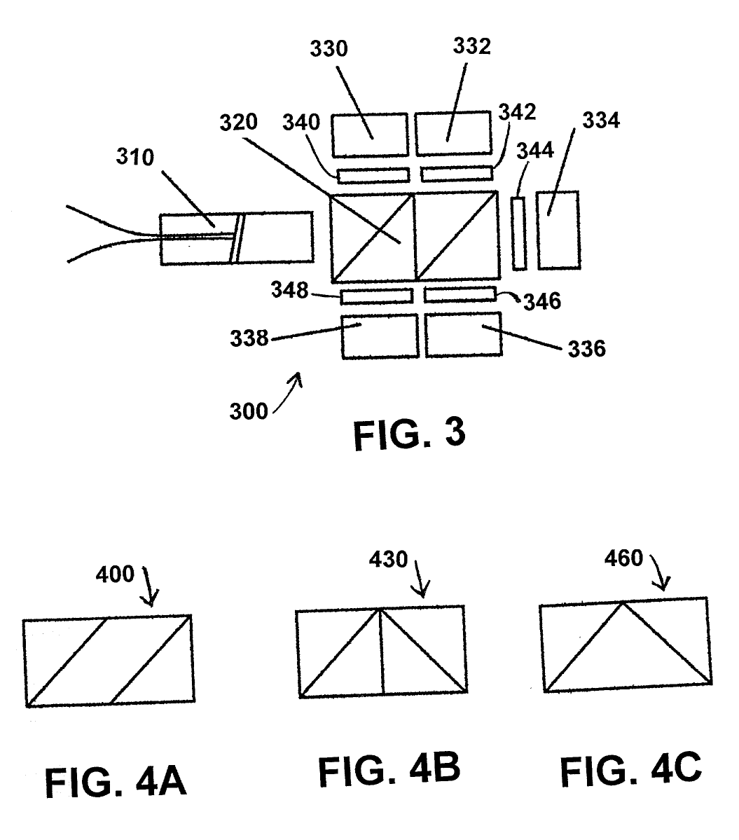

FIG. 3 illustrates a device 300 with five optical filtering elements in a cascade. This cascade consists of an elongated PBS (320), five filtering elements (330, 332, 334, 336, and 338), five 45-degree Faraday rotators (340, 342, 344, 346 and 348), and an input/output dual fiber collimator 310. The elongated PBS (320) consists of two cubic PBSs placed side by side. In order to reduce the overall insertion loss of the device, all optical surfaces of the PBS, one of the surfaces of the filtering elements, as well as both surfaces of the Faraday rotators have anti-reflective coatings. The operational principle of this device is identical to that of the device illustrated in FIG. 2. The s-polarization component of the incoming light reaches filtering elements 330, 338, 332, 336, 334 in order, and then returns to the input/output collimator 310. The p-polarization of the input, on the other hand, reaches filtering elements in the order of 334, 336, 332, 338, and 330 and returns to the input/output collimator 310. The light beams associated with selected channels of each filtering element, pass through these filters and are collected through output collimators (not shown).

The elongated PBS 320 of FIG. 3, has a function identical to two cubic PBSs 220 in FIG. 2 placed side by side. There are therefore many other PBS designs that offer similar functions and yield cascade configurations similar to the one disclosed in to FIG. 3. In FIG. 4, three such equivalent PBS's 400, 430 and 460 are shown. In order to reduce overall device insertion loss, anti-reflective coatings are deposited on the interfacing optical surfaces that form the respective interior boundaries of these PBSs.

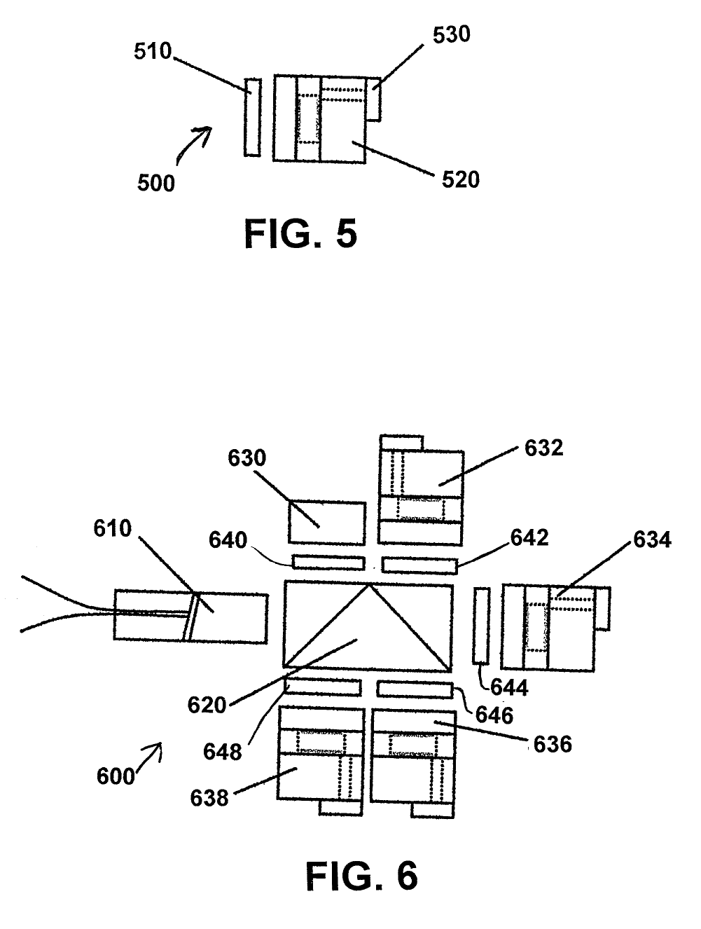

In many optical communication applications, one frequently uses periodic phase modulators. A particularly useful phase modulating device is known as a Gires-Tournois (GT) mirror. A GT mirror consists of a partial reflector, a precision spacer, and a full reflector. A relevant disclosure of FSR and phase tunable GT mirrors is found in is USPTO 09/742,749, filed on Mar. 2, 2001, by Charles Qian. The Qian application is incorporated herein by reference as relevant background material. In FIG. 5, the combination 500 of a GT mirror (520) with a 45-degree Faraday rotator (510) is disclosed. Such a combination rotates the incoming light polarization by 90 degrees while adding periodic phase shifts. In order to reduce overall device insertion loss, anti-reflective coatings are deposited on both surfaces of the Faraday rotator and the front surface of the GT mirror. To maintain the thermal stability of the GT mirror, an air-spaced GT mirror is used with a spacer made with low thermal expansion material. The cavity is hermetically sealed with another piece of glass (530).

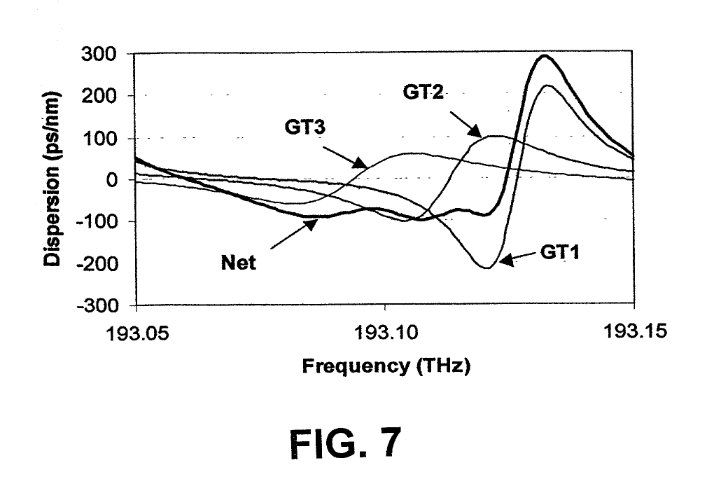

FIG. 6 illustrates a cascade device 600 consisting of four GT mirrors (632, 634, 636, and 638), according to the present invention. A regular mirror 630, acting simply as a reflector, is used to complete the cascade. Similar to the device disclosed in FIG. 3, an elongated PBS (620) and five 45-degree Faraday rotators are employed. A cascade of GT mirrors is suitable to provide periodic phase compensations that can be used to correct chromatic dispersion associated with optical fiber transmission. The partial reflective coatings of the GT mirrors, as well as their FSRs, are designed and adjusted, respectively, to yield the desired dispersion compensation. In FIG. 7, a particular device designed with three cascade GT mirrors (a physical device similar to the one displayed in FIG. 2) yielded −100 ps/nm dispersion compensation. The partial reflectors of the GT mirrors used in these devices have reflectivity in the range of 0% to 40% where as the whole reflector has reflectivity close to 100%. The reflectivity of the partial reflectors may also be functions of wavelength in order to correct for dispersion slope.

It will be apparent to those with ordinary skill of the art that many variations and modifications can be made to these cascade devices disclosed herein without departing form the spirit and scope of the present invention. It is therefore intended that the present invention cover the modifications and variations of this invention provided that they come within the scope of the appended claims and their equivalents.

1. An optical filtering device comprising:
a 45 degree Faraday rotator; and
an optical filtering element aligned with said rotator.

2. The device recited in claim 1, said rotator having input and output optical surfaces and wherein at least one of said surfaces is coated with an anti-reflective material.

3. The device recited in claim 1 wherein a selected optical surface of said filtering element comprises a bandpass coating, said bandpass corresponding to selected wavelength channels.

4. The device recited in claim 3 wherein another optical surface of said filtering element comprises an anti-reflective material coating.

5. The device recited in claim 1 wherein said rotator and said filtering element are in contact with one another.

6. The device recited in claim 5 wherein said rotator and said filtering element are affixed to one another.

7. An optical beam modifying device in a cascade configuration and comprising:
a 45 degree Faraday rotator; and
a combination of optical elements aligned with said rotator, said combination having means for modifying the polarization, intensity and phase of incoming light and for reflecting the modified beam.

8. An optical device comprising:
a polarizing beam splitter configured for receiving input light having a plurality of polarization components and separating said polarization components by their respective orientation to produce output light, said beam splitter having a plurality of entrance and exit surfaces, at least one of said surfaces receiving said input light and producing said output light; each of the remaining said surfaces being aligned with a respective light modification component for altering at least one characteristic of input light components.

9. The device recited in claim 8 wherein each said modification component comprises a 45 degree Faraday rotator aligned with a filtering element.

10. The device recited in claim 8 further comprising a dual optical fiber collimator aligned with said at least one input and output light surface.

11. The device recited in claim 8 further comprising anti-reflective coatings on each of said beam splitter surfaces and on at least one optical surface of said light modification components.

12. The device recited in claim 8 wherein said beam splitter comprises a plurality of contiguous prisms.

13. The device recited in claim 12 wherein at least two of said prisms abut along a surface that is oriented diagonally relative to light passing through said beam splitter.

14. The device recited in claim 8 wherein each said modification component comprises a 45 degree Faraday rotator aligned with a Gires-Tournois mirror.

15. An optical device comprising:
a 45 degree Faraday rotator; and
a Gires-Tournois mirror aligned with said rotator for selective phase modulation of incident light.
